(19) United States
(12) Patent Application Publication
(10) Pub. No.: US 2025/0157211 A1
(43) Pub. Date: May 15, 2025

(54) METHOD AND APPARATUS FOR DETECTING CHANGES IN AN ENVIROMENT

(71) Applicant: Telefonaktiebolaget LM Ericsson (publ), Stockholm (SE)

(72) Inventors: Volodya GRANCHAROV, Solna (SE); Manish SONAL, Sollentuna (SE)

(21) Appl. No.: 18/726,956

(22) PCT Filed: Feb. 8, 2022
(86) PCT No.: PCT/EP2022/053017

§ 371 Date: Jul. 5, 2024

(51) Int. Cl. G06V 10/96; G06V 10/74; G06V 10/75; G06V 20/50

(52) U.S. Cl. CPC G06V 10/96; G06V 10/751; G06V 10/761; G06V 20/50

(57) ABSTRACT

A method for detecting changes in a physical environment is provided. The method is performed by an apparatus. The method includes obtaining a first image representing the physical environment at a first time instance, and obtaining a second image representing the physical environment at a second time instance. The method further includes using the second image as input to a set of machine learning, ML, models to generate a reconstructed image of the second image from each of the set of ML model, and selecting an ML model among the set of ML models with a smallest reconstruction error between the second image and the generated reconstructed image of the second image. The method further includes detecting if there are changes in the physical environment by using the first image and the second image as input to the selected ML model.

### TECHNICAL FIELD

The present disclosure pertains to the field of computer vision. More particularly, the present disclosure pertains to an apparatus and a method for detecting changes in a physical environment.

### BACKGROUND

Automatic detection of changes in a physical environment has been widely used in many industrial applications such as video surveillance, medical diagnosis, telecom infrastructure maintenance and remote sensing. For example, highlighting “before” and “after” state of a physical environment guides a technician to troubleshoot a telecom cell site. For detecting changes in the physical environment, a camera (in a handheld device, drone, etc.) may be used to capture the physical environment information represented as for example a set of RGB images and compare the images. When camera is used, detecting changes in a physical environment has the same meaning as detecting changes in a visual scene representing the physical environment. Often, scene change detection aims at object-level detection independent of camera viewpoints, illumination conditions, photographing conditions etc.

One solution to the problem of scene change detection is in three-dimensional (3D) domain by building 3D models at different times and comparing these models. In practice, this solution may require large computational cost and is therefore not feasible. For example, in the scenario of troubleshooting a telecom cell site, the device carried by a technician may only have limited capacity and there may be urgent needs to repair a cell site if it is down. For these reasons it is more common to detect scene changes directly in two-dimensional (2D) image domain, without building 3D models.

The problem of 2D image change detection was discussed for example in Sakurada, Ken and Okatani, Takayuki, “Change Detection from a Street Image Pair using CNN Features and Superpixel Segmentation”, Proceedings of British Machine Vision Conference (BMVC), pp. 61.1-61.12, 2015. In this paper, a pair of images is compared to detect scene changes, and convolutional neural network (CNN) models are used for extracting features from images. CNN based feature extraction often outperforms the alternative 2D change detection algorithms. However, a CNN model performs best if images required for comparison are visually similar to the images used for training the CNN model. As an example, a CNN model trained using images from base station installation will outperform in extracting features from images related to telecom devices but will not perform well in extracting features from images related to agricultural applications. One solution to this problem is to use features extracted from CNN trained on a very large set of images from different industrial applications. Such CNN training will take long time and require high computational capacity. Moreover, this very large set of images has very little similarity to images from specific industrial scenes (e.g., telecom site, power grid, factory environment site), so it still brings suboptimal performance to those industrial applications.

### SUMMARY

An object of the present disclosure is to provide a method, an apparatus, a computer program, a computer program product and a carrier which seek to mitigate, alleviate, or eliminate one or more of the above-identified deficiencies in the art and disadvantages singly or in any combination.

According to a first aspect of the invention there is presented a method for detecting changes in a physical environment. The method is performed by an apparatus. The method comprises obtaining a first image representing the physical environment at a first time instance. The method comprises obtaining a second image representing the physical environment at a second time instance. The method comprises using the second image as input to a set of machine learning (ML) models to generate a reconstructed image of the second image from each of the set of ML models. The method comprises selecting an ML model among the set of ML models with a smallest reconstruction error between the second image and the generated reconstructed image of the second image. The method further comprises detecting if there are changes in the physical environment by using the first image and the second image as input to the selected ML model.

According to a second aspect of the invention there is presented an apparatus for detecting changes in a physical environment. The apparatus comprises a processing circuitry. The processing circuitry causes the apparatus to be operative to obtain a first image representing the physical environment at a first time instance. The processing circuitry causes the apparatus to be operative to obtain a second image representing the physical environment at a second time instance. The processing circuitry causes the apparatus to be operative to use the second image as input to a set of machine learning (ML) models to generate a reconstructed image of the second image from each of the set of ML models. The processing circuitry causes the apparatus to be operative to select an ML model among the set of ML models with a smallest reconstruction error between the second image and the generated reconstructed image of the second image. The processing circuitry further causes the apparatus to be operative to detect if there are changes in the physical environment by using the first image and the second image as input to the selected ML model.

According to a third aspect of the invention there is presented a computer program comprising instructions which, when executed on a processing circuitry, cause the processing circuitry to perform the method of the first aspect.

According to a fourth aspect of the invention there is presented a computer program product comprising a computer readable storage medium on which a computer program according to the third aspect, is stored.

According to a fifth aspect of the invention there is a carrier containing the computer program according to the third aspect, wherein the carrier is one of an electronic signal, an optical signal, a radio signal, and a computer readable storage medium.

Advantageously, these aspects provide a way of detecting scene changes accurately since the detection is adapted to the context of the scene (e.g., various industrial applications). More specifically, a ML model trained on images similar to an environment at test is automatically selected for detecting changes, which results in a more robust and accurate detection.

Other objectives, features and advantages of the enclosed embodiments will be apparent from the following detailed disclosure, from the attached dependent claims as well as from the drawings.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 is a schematic view of an example scenario in accordance with some embodiments of the present disclosure;

FIG. 2 is a flowchart illustrating a method according to some embodiments of the present disclosure;

FIG. 3 is a block diagram illustrating a method for detecting changes in a physical environment in accordance with some embodiments of the present disclosure;

FIG. 4 is a block diagram illustrating a CAE model in accordance with some embodiments of the present disclosure;

FIG. 5 is a block diagram of an apparatus in accordance with some embodiments of the present disclosure;

FIG. 6 shows an embodiment of a computer program product comprising computer readable storage medium according to some embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description of the figures.

The terminology used herein is for the purpose of describing particular aspects of the disclosure only, and is not intended to limit the invention. As used herein, the singular forms “a”, “an” and “the” are intended to include the plural forms as well, unless the context clearly indicates otherwise.

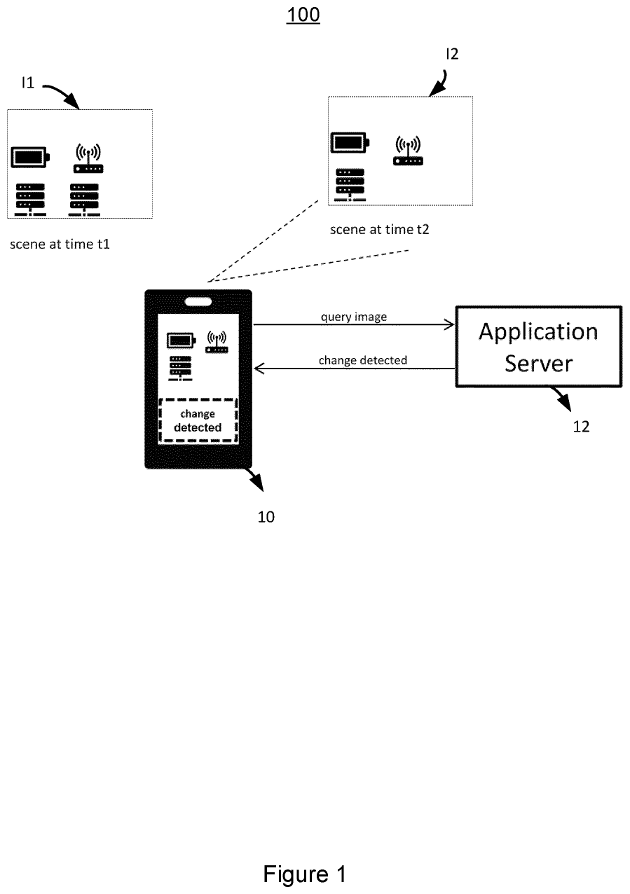

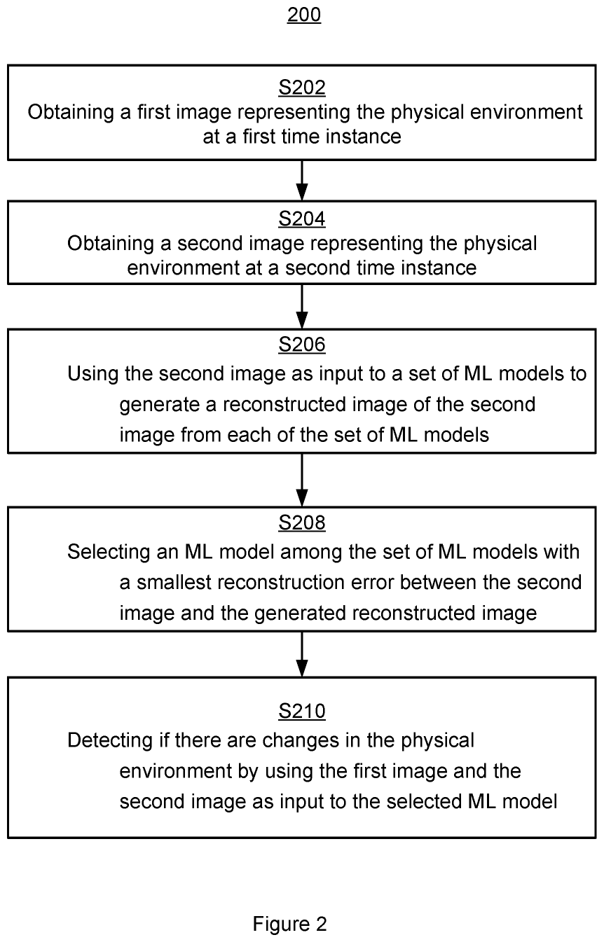

FIG. 1 is a schematic view of an example scenario 100 in accordance with some embodiments of the present disclosure. In this example, an example embodiment of the present disclosure is integrated into a software application (i.e., “app”) of an apparatus 10 (e.g., a mobile phone). When a technician visits a cell site, there has already been historical visual data of the cell site, for example, an image I1 capturing a set of equipment at a scene at time instance t1. The historical visual data of the cell site may be uploaded and saved on an application server 12. The technician takes an image I2 of the same scene at a later time instance t2, and in this example one piece of equipment is missing in the image I2 as compared with I1. Optionally, the image I2 is a used as a query image to retrieve the image I1 that is most similar to the query image from the historical visual data of the cell site. The software application may detect scene changes between images I1 and I2, and if there are noticeable scene changes, the technician is notified by an alert such as “changes detected” on the apparatus 10. Further details of the example scenario will be illustrated below together with FIG. 2.

FIG. 2 is a flowchart illustrating a method 200 according to some embodiments of the present disclosure. The method 200 may be used for detecting changes in a physical environment. The method may be performed by an apparatus 500. The method may be advantageously provided as a computer program 620. The method comprises the steps as following:
S202: Obtaining a first image representing the physical environment at a first time instance.
S204: Obtaining a second image representing the physical environment at a second time instance.

A physical environment may be an indoor or an outdoor environment. A physical environment may be a surrounding environment through which an apparatus is moving. A physical environment may be characterized by context since objects, or conditions of a physical environment may be industrial application specific. In the present disclosure images of a physical environment is registered, so a physical environment may mean the same thing as a visual environment or a scene. In some embodiments an image is specifically a 2D image.

The time interval between the first time instance and the second time instance may be measured by years, months, weeks, days, hours, minutes, seconds etc. depending on the need. For example, a technical may after several months have another visit to a cell site to check if there are noticeable changes. For a security camera surveillance system, there may be several seconds between the first time instance and the second time instance to check if something has changed in a physical environment.

In some embodiments, the first image is among a plurality of images. In some embodiments, the plurality of images are historical images of the physical environment. In some embodiments the first image is among a plurality of images most similar to the second image. In some embodiment the first image is pre-determined or pre-selected, for example, for a following visit of a physical environment, an image taken from a previous visit may be the first image. In some embodiments different image retrieval techniques may be used for determining the first image.

The method 200 further comprises:
S206: Using the second image as input to a set of machine learning, ML, models to generate a reconstructed image of the second image from each of the set of ML models.

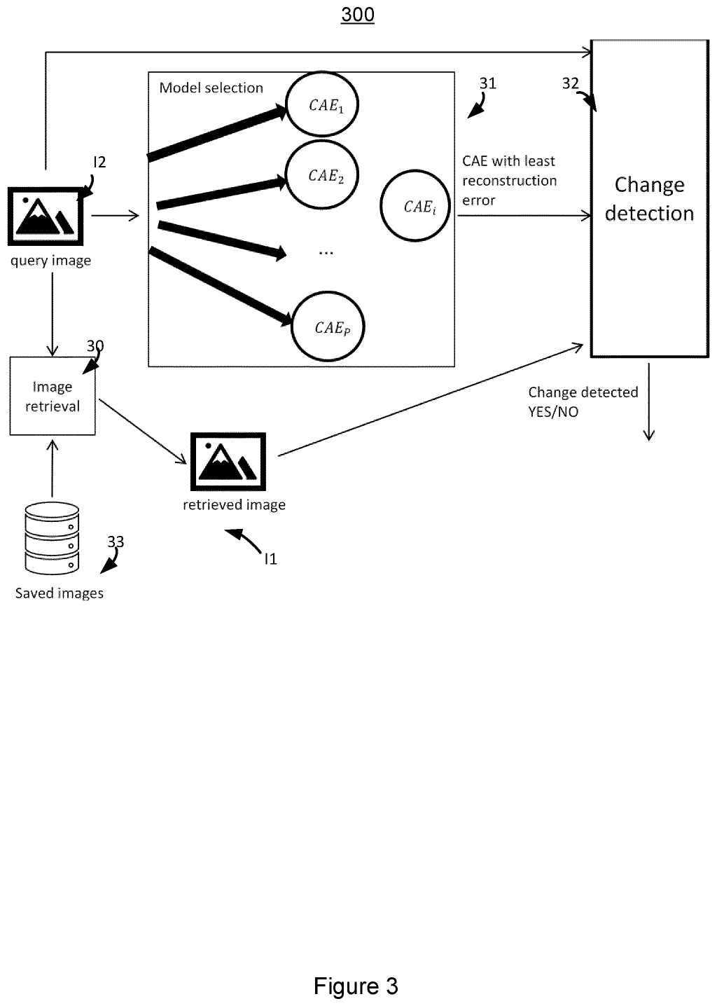

The term “model” used in ML area may indicate a specific set of trained parameters (based on the training set). In some embodiments, each of the set of ML models is an Autoencoder (AE). The ML mode may include an encoder part and a decoder part. By using an encoder an original image (e.g., the second image) may be compressed into a small coding. By using a decoder the small coding is decompressed into a reconstructed image of the original image. In some embodiments, each of the set of ML models is an ML model with a Convolutional Autoencoder, CAE, structure. Further details regarding Autoencoder and CAE are provided later together with FIG. 3.

The method 200 further comprises:

S208: Selecting an ML model among the set of ML models with a smallest reconstruction error between the second image and the generated reconstructed image of the second image

Assume that some information is lost during a reconstruction and the reconstruction is not exact, a reconstruction error may be used to indicate the differences between the original image (e.g., a second image) and the reconstructed image. In some embodiments the smallest reconstruction error is calculated based on at least one of: Mean Squared Error (MSE), Normalized Cross-Correlation (NCC), Structural Similarity Index Measure (SSIM), and Peak Signal-to-Noise Ratio (PSNR).

The method 200 further comprises:

S210: Detecting if there are changes in the physical environment by using the first image and the second image as input to the selected ML model.

In some embodiments, the detecting if there are changes in the physical environment comprises comparing feature vectors of the first image with feature vectors of the second image, wherein the feature vectors are generated by the selected ML model. Euclidean distance may be used to calculate a distance between two feature vectors. The selected ML model may generate both feature vectors of an input image (e.g., a second image) and a reconstructed image of the input image.

In some embodiments, the detecting if there are changes in the physical environment comprises transforming and aligning the first image and the second image before using the first image and the second image as input to the selected ML model.

In some embodiments, the first image and the second image are divided into grid cells, and each grid cell is associated with a feature vector.

In some embodiments, a grid cell of the second image is dissimilar from the corresponding grid cell of the first image if a distance between a feature vector associated with the grid cell of the second image and a feature vector associated with the corresponding grid cell of the first image is above a dissimilarity threshold.

In some embodiments, the detecting if there are changes in the physical environment is based on grid cells of the second image that are dissimilar from the corresponding grid cells of the first image.

In some embodiments, the detecting if there are changes in the physical environment is based on grid cells of the second image that are dissimilar from the corresponding grid cells of the first image and have a number of neighboring grid cells dissimilar from the corresponding grid cells of the first image.

In some embodiments, the method further comprises in response to detecting that there are changes in the physical environment, initiating a message to a user indicating that the physical environment has changed.

In some embodiments, the apparatus is a wireless communication device. The second image may be captured by a camera of the wireless communication device. The first image may be a historical image that is received by the wireless communication device from an external database. The initiating a message to a user indicating that the physical environment has changed may further comprise notifying the user by an alert on a screen of the wireless communication device.

In some embodiments, the apparatus is an application server. The first image and the second image may be captured by a device separate from the apparatus. The device separate from the apparatus may be a wireless communication device integrated with a camera. The application server may have the first image stored among other historical images in an internal or external database. The application server may receive a request together with a query image from a mobile phone of a user requiring the application server to detect if there are visual changes in the physical environment. The application server may retrieve the first image since the first image is the image most similar to the second image (i.e., query image). The application server may evaluate and select a CAE model that is most suitable for this environment from a set of CAE models, based on a smallest reconstruction error between the second image and the reconstructed image of the second image. The application server may extract features using the selected CAE model for the retrieved image and the query image. The application server may then detect visual differences between the retrieved image (i.e., the first image) and the query image (i.e., the second image) by comparing the extracted features of the retrieved image and the query image. The application server may send a message to the mobile phone of the user so that the mobile phone of the user will show on its screen an alert that there are visual changes detected.

If the method 200 is integrated into a software application (“app”) for the example scenario 100 of FIG. 1, in one embodiment, the technician may use his/her mobile phone to visualize scene changes and the visual change detection is adapted to the context by the selection of a set of CAE models. The technician or some other users, in his/her previous site visit(s) takes images of the physical environment which are then uploaded and saved on the application server. One of these historical images is image I1 taken at t1. The technician on a subsequent visit (e.g., present moment in time), wants to see if something has changed in a particular part of the physical environment. The technician points the camera to a certain location in the physical environment and takes an image I2 (in other words, a query image or a second image) with the application at time t2. The application retrieves the image I1 (in other words, a retrieved image or a first image) taken at time t1 from the historical images since the image I1 is determined most similar to the image I2. The application evaluates and selects a CAE model that is most suitable for this physical environment from a set of CAE models based on a smallest reconstruction error between the image 12 and the reconstructed image of the image I2. The application extracts features using the selected CAE model for both images I1 and I2. The application then detects changes between images I1 and I2 based on the extracted features. The application may notify the user in response to detecting that there are changes in the physical environment.

An autoencoder is a type of unsupervised neural network that summarize common properties of data in fewer parameters while learning how to reconstruct it after compression. An autoencoder compress the input into a lower-dimensional projection and then reconstruct the output from this representation. By using autoencoder easy check can be performed to see if a certain model fits a certain visual environment. There are different variants of autoencoders: from fully connected to convolutional. Fully connected autoencoder can be considered as multi-layer perceptron where neurons contained in a particular layer are connected to each neuron in the previous layer. Within an artificial neural network, a neuron is a mathematical function that model the functioning of a biological neuron. A neuron receives a vector of inputs, performs a transformation on them, and outputs a single scalar value. With a CAE, neurons are connected to a few nearby neurons in the previous layer which is suitable for capturing patterns in pixel-data since neighboring information is kept. In such a way, spatial relations between extracted features and locations in the original image domain are preserved.

For example, CAE model proposed in Lei Zhou, Zhenhong Sun, Xiangji Wu, Junmin Wu, “End-to-end Optimized Image Compression with Attention Mechanism”, CVPR, 2019, may be used. There may be a set of CAE models that are trained on different image sets relevant to the industrial applications at hand. The term “model” used in artificial neural network area may indicate a specific set of trained neural network parameters (based on the training set). This means that there may be a great number of “models” of a CAE type for detecting visual differences targeting at different industrial applications. The set of CAE models is trained in an unsupervised setup that does not require expensive labeling. There may be an automatic switch between the set of CAE models based on context/industrial applications. The features extracted from the best suited CAE model may then be used for detecting visual changes.

FIG. 3 is a block diagram illustrating a method 300 for detecting changes in a physical environment in accordance with some embodiments of the present disclosure. There are three main components: image retrieval, model selection and change detection.

1) Image retrieval 30: At time t2, an image I2 (i.e., a query image) is taken from an area in the physical environment. The area may include objects of interests. The image retrieval block 30 retrieves from a database 33 with saved images, an image I1 (i.e., the retrieved image) most similar to I2 using image retrieval techniques (see e.g., Dharani, T., and I. Laurence Aroquiaraj, “A survey on content-based image retrieval”, 2013 International Conference on Pattern Recognition, Informatics and Mobile Engineering, IEEE, pp. 485-490, 2013).

2) Model selection 31: The query image taken at time t2, is used to select the best CAE model caeᵢ, i=1, . . . , P, where P is a total number of CAE models. The model selection is performed by calculating a reconstruction error between the query image and the reconstructed image outputted from the CAE model caeᵢ.

$${error}_{i} = reconstruction error ( {cae}_{i} , {image}_{query} ) , i = 1 , … , P$$

The caeᵢ that gives a minimum/smallest reconstruction error errorᵢ among all CAE models is selected as the most suitable CAE model for this context/industrial application. The underlying assumption is that the CAE model that reconstructs an image well will produce the most relevant features.

The reconstruction error can be calculated using algorithms such as pixel wise Mean Squared Error (MSE), so that

$${MSE}_{{I}_{2} {I}_{2 \_ reconstructed}} = \frac{{{\sum }_{M , N} [ {I}_{2} ( m , n ) - {I}_{2 \_ reconstructed} ( m , n ) ]}^{2}}{M * N} ,$$

In the above formular, I₂ represents the query image, I_{2_reconstructed} represents the reconstructed image for the query image outputted by a CAE model caeᵢ, and M, N are image dimensions, i.e., width and height in pixels. For two images I₂ and I_{2_reconstructed}, the square of the difference between every pixel in I₂ and the corresponding pixel in I_{2_reconstructed} are calculated, summed up and divided by a total number of pixels of the image.

The MSE_{I}_{₂}_{I}_{_{2_reconstructed}} for each CAE model of the set of CAE models are compared and the CAE model with the minimum/smallest error is selected for detecting visual changes between the query image and the retrieved image.

3) Change detection 32: The retrieved image and the query image may be transformed and aligned before visual difference detection. In some embodiments, Scale-invariant feature transform (SIFT) (see e.g., Lowe, David G., “Object recognition from local scale-invariant features”, Proceedings of the International Conference on Computer Vision. doi:10.1109/ICCV.1999.790410, 1999) and Random sample consensus (RANSAC) (see e.g., Fischler M. A., and Bolles R. C., “Random Sample Consensus: A Paradigm for Model Fitting with Applications to Image Analysis and Automated Cartography”, Communication ACM, 24(6), pp. 381-395, 1981) may be used to estimate a homography matrix between these two images, then transform the query image onto the plane of the retrieved image using the estimated homography matrix. The homography matrix is a mapping between two image planes.

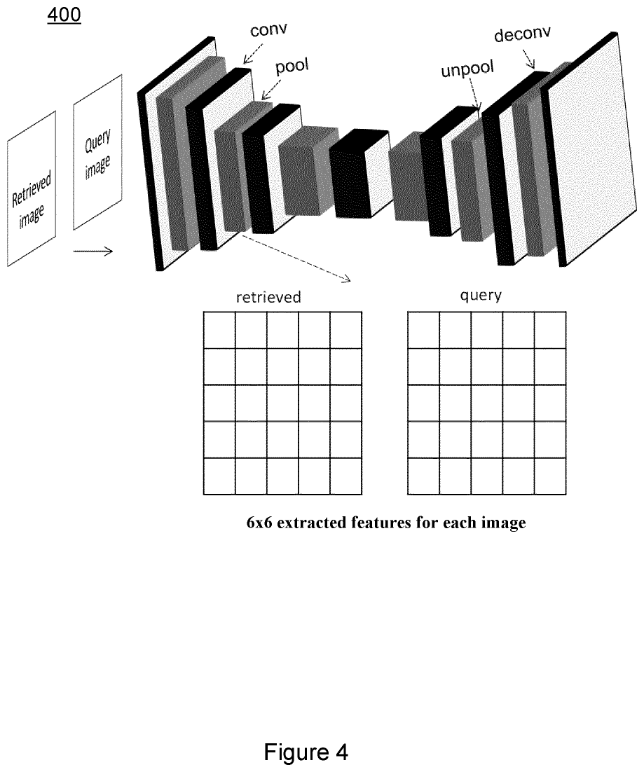

FIG. 4 is a block diagram illustrating a CAE model 400. In FIG. 4, the retrieved image and the query image are put side by side into this selected CAE model 400 for feature extraction. The CAE model 400 comprises of convolution layer(s), pooling layer(s), unpooling layer(s), and deconvolution layer(s). Convolutional layer(s) and pooling layer(s) belong to encoder part where a convolution layer learns different features from the input image and a pooling layer reduces the dimensionality while keeping the learned features. Unpooling layer(s) and deconvolution layer(s) belong to decoder part where a deconvolution layer is to increase the size of the output feature maps and an unpooling layer is used to restore values which were subsampled, so that the original input image can be decoded.

This CAE model 400 only illustrates a non-limiting embodiment. In some embodiments, other types of CAE models that differ structurally from this CAE model can be used, such as a CAE model without pooling layer(s) and unpooling layer(s), and a CAE model that replaces unpooling layer(s) with unsampling layer(s).

Each input image may be divided into a specified number of grid cells. A feature (i.e., feature vector) is extracted for each grid cell. For illustrating purpose, the query image and the retrieved image are divided into 6×6 uniform grid cells. In some embodiments, for a pooling layer, each location in the pooling layer may be mapped to a grid location in the input image, thus each grid cell is associated with a feature vector corresponding to the activation of all the units in that location across all the feature maps of the pooling layer. By activation it means the output value from the convolutional layer filters with an activation function that is a non-linear transformation (e.g., sigmoid, tanh) of the output value. Using a pooling layer for feature extraction is a non-limiting embodiment and a convolutional layer may also be used for feature extraction. In this illustrating example, each of the query image and the retrieved image has 6×6 extracted features and each of the feature vectors corresponds to a grid cell. These feature vectors are then normalized to unit vectors.

For two corresponding feature vectors associated with two corresponding grid cells of the query and the retrieved image, the Euclidean distance is calculated and compared with a dissimilarity threshold (i.e., a dissimilarity score) θ (see e.g., Sakurada, Ken and Okatani, Takayuki. “Change Detection from a Street Image Pair using CNN Features and Superpixel Segmentation”. In: January. 2015, pp. 61.1-61.12. DOI: 10.5244/C.29.61). Optionally, any value above the dissimilarity threshold θ contributes to the dissimilarity between the two images. Optionally, the dissimilarity threshold θ may have a value 0.8. Optionally, a grid cell of the query image having a distance to a corresponding grid cell of the retrieved image above the dissimilarity threshold θ is considered as a grid cell with dissimilarity. Alternatively, a grid cell of the query image having a distance to a corresponding grid cell of the retrieved image above the dissimilarity threshold θ and having a number of neighboring grid cells with distances above 0 to corresponding grid cells of the retrieved image is considered as a grid cell with dissimilarity. Optionally, a total percentage of neighboring grid cells with distances above a dissimilarity threshold θ is calculated, and compared with a percentage neighboring threshold such as 30% of all neighboring grid cells. For example, if a grid cell of the query image has a distance above the dissimilarity threshold θ to the corresponding grid cell of the retrieved image, and has above 30% neighboring grid cells with distances to corresponding grid cells of the retrieved image above (i.e., greater than) the dissimilarity threshold θ, the grid cell is considered as a grid cell with dissimilarity (i.e., the grid cell in the retrieved image is dissimilar to the corresponding grid cell in the query image). The reason to use neighboring grid cells is that grid cells are simply areas over objects in an image. It is thus unlikely that a grid cell boundary coincides exactly with an object that was present for example at time instance t1 but is missing at time instance t2, and determining dissimilarity based on a single grid cell may introduce noises. By determining dissimilarity based on a number of grid cells in the neighborhood, the noises may be reduced and performance of change detection may be more stable. Optionally, a total number of grid cells of an image with dissimilarity is calculated and compared with a percentage threshold. Optionally, if a percentage of grid cells with dissimilarity is above 25% of all grid cells, the query image and retrieved image are considered as different and changes are detected.

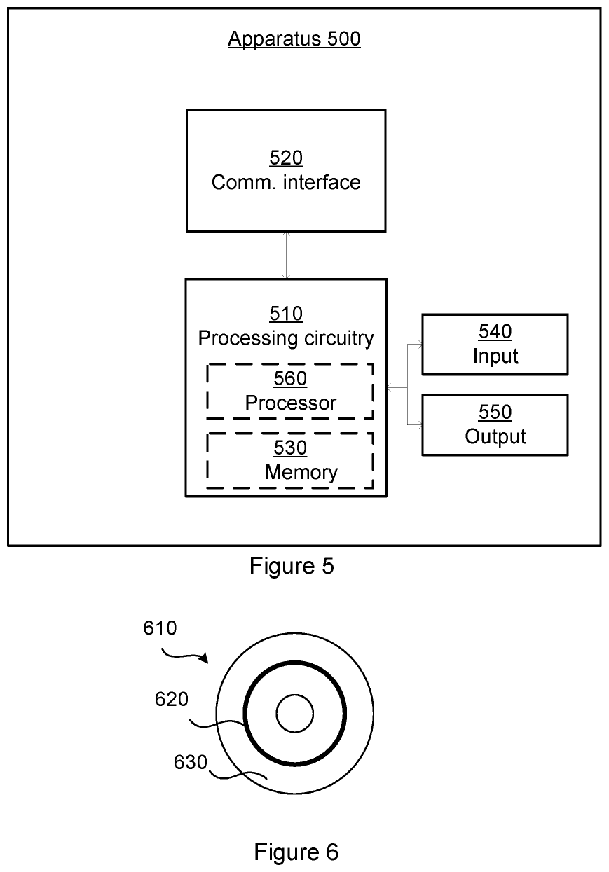

FIG. 5 schematically illustrates, in terms of functional units, the components of an apparatus 500 according to an embodiment. Processing circuitry 510 is provided using any combination of one or more of a suitable central processing unit (CPU), multiprocessor, microcontroller, digital signal processor (DSP), etc. The processing circuitry 510 may comprises a processor 560 and a memory 530 wherein the memory 530 contains instructions executable by the processor 560. The memory 530 may further contain the computer program product 610 (as shown in FIG. 6). The processing circuitry 510 may further be provided as at least one application specific integrated circuit (ASIC), or field programmable gate array (FPGA). The device may comprise input 540 and output 550. The apparatus may comprise a camera, for example a video camera or a still image camera (not shown in FIG. 5).

The apparatus 500 may further comprise a communication interface 520. The communication interface 520 may implement one or more of various wireless technologies, such as Wi-Fi, Bluetooth, Zigbee, and so on. A wired network interface, e.g., Ethernet (not shown in FIG. 5) may further be provided as part of the apparatus 500 to facilitate a wired connection to a network, or a plug-in network device that communicates with other wireless networks.

Particularly, the processing circuitry 510 is configured to cause the apparatus 500 to perform a set of operations, or steps, as disclosed above. For example, the memory 530 may store instructions which implement the set of operations, and the processing circuitry 510 may be configured to retrieve the instructions from the memory 530 to cause the apparatus 500 to perform the set of operations.

Thus, the processing circuitry 510 is thereby arranged to execute methods as herein disclosed. The memory 530 may also comprise persistent storage, which, for example, can be any single one or combination of magnetic memory, optical memory, solid state memory or even remotely mounted memory.

In some embodiments the device is a wireless communication device. The wireless communication device, such as a mobile station, a non-access point (non-AP) station (STA), a STA, a user equipment (UE) and/or a wireless terminal, may communicate via one or more access networks (AN), e.g., radio access network (RAN), to one or more core networks (CN). It should be understood by the skilled in the art that “wireless communication device” is a non-limiting term which means any terminal, wireless communication device, user equipment, Machine-Type Communication (MTC) device, Device-to-Device (D2D) terminal, or node e.g., smartphone, laptop, mobile phone, sensor, relay, mobile tablets or even a small base station capable of communicating using radio communication with a radio network node within an area served by the radio network node. In some embodiments, the wireless communication device may include a downloadable software application (or “app”) that can be used to provide a notification to a user for example when visual changes of an environment have been detected. The wireless communication devices can be carried or operated by any one of a number of individuals. These individuals may include wireless communication device owners, wireless communication device users, or others.

In some embodiments the apparatus 500 is a server. In some embodiments the device is an application server. An application server may be a mixed framework of software that allows both the creation of web applications and a server environment to run them. An application server may physically or virtually sit between database servers storing application data and web servers communicating with clients. An application server may have an internal database or may be connected to an external database.

FIG. 6 shows one example of a computer program product 610 comprising computer readable storage medium 630. On this computer readable storage medium 630, a computer program 620 can be stored, which computer program 620 can cause the processing circuitry 510 and thereto operatively coupled entities and devices, such as the communications interface 520, to execute methods according to embodiments described herein. The computer program 620 and/or computer program product 610 may thus provide means for performing any steps as herein disclosed.

In the example of FIG. 6, the computer program product 610 is illustrated as an optical disc, such as a CD (compact disc) or a DVD (digital versatile disc) or a Blu-Ray disc. The computer program product 610 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 620 is here schematically shown as a track on the depicted optical disk, the computer program 620 can be stored in any way which is suitable for the computer program product 610. A carrier may contain the computer program 620, wherein the carrier is one of an electronic signal, an optical signal, a radio signal, and a computer readable storage medium 630.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for detecting changes in a physical environment, the method performed by an apparatus and comprising:
obtaining a first image representing the physical environment at a first time instance;
obtaining a second image representing the physical environment at a second time instance;
using the second image as input to a set of machine learning, ML, models to generate a reconstructed image of the second image from each of the set of ML models;
selecting an ML model among the set of ML models with a smallest reconstruction error between the second image and the generated reconstructed image of the second image; and
detecting if there are changes in the physical environment by using the first image and the second image as input to the selected ML model.

2. The method of claim 1, wherein each of the set of ML models is an ML model with a Convolutional Autoencoder, CAE, structure.

3. The method of claim 1, wherein the first image is among a plurality of images most similar to the second image.

4. The method of claim 1, wherein the detecting if there are changes in the physical environment comprises comparing feature vectors of the first image with feature vectors of the second image, wherein the feature vectors are generated by the selected ML model.

5. The method of claim 1, wherein the smallest reconstruction error is calculated based on at least one of: Mean Squared Error (MSE), Normalized Cross-Correlation (NCC), Structural Similarity Index Measure (SSIM), and Peak Signal-to-Noise Ratio (PSNR).

6.-7. (canceled)

8. The method of claim 1, wherein the first image and the second image are divided into grid cells, and each grid cell is associated with a feature vector, wherein a grid cell of the second image is dissimilar from the corresponding grid cell of the first image if a distance between a feature vector associated with the grid cell of the second image and a feature vector associated with the corresponding grid cell of the first image is above a dissimilarity threshold, wherein the detecting if there are changes in the physical environment is based on grid cells of the second image that are dissimilar from the corresponding grid cells of the first image.

9. The method of claim 1, wherein the first image and the second image are divided into grid cells, and each grid cell is associated with a feature vector, wherein a grid cell of the second image is dissimilar from the corresponding grid cell of the first image if a distance between a feature vector associated with the grid cell of the second image and a feature vector associated with the corresponding grid cell of the first image is above a dissimilarity threshold, wherein the detecting if there are changes in the physical environment is based on grid cells of the second image that are dissimilar from the corresponding grid cells of the first image and have a number of neighboring grid cells dissimilar from the corresponding grid cells of the first image.

10. The method of claim 1, further comprising: in response to detecting that there are changes in the physical environment, initiating a message to a user indicating that the physical environment has changed.

11.-15. (canceled)

16. An apparatus for detecting changes in a physical environment, the apparatus comprising a processing circuitry causing the apparatus to be operative to:
obtain a first image representing the physical environment at a first time instance;
obtain a second image representing the physical environment at a second time instance;
use the second image as input to a set of machine learning, ML, models to generate a reconstructed image of the second image from each of the set of ML models;
select an ML model among the set of ML models with a smallest reconstruction error between the second image and the generated reconstructed image of the second image; and
detect if there are changes in the physical environment by using the first image and the second image as input to the selected ML model.

17. The apparatus of claim 16, wherein each of the set of ML models is an ML model with a Convolutional Autoencoder, CAE, structure.

18. The apparatus of claim 16, wherein the first image is among a plurality of images most similar to the second image.

19. The apparatus of claim 16, wherein to detect if there are changes in the physical environment comprises to compare feature vectors of the first image with feature vectors of the second image, wherein the feature vectors are generated by the selected ML model.

20. The apparatus of claim 16, wherein the smallest reconstruction error is calculated based on at least one of: Mean Squared Error (MSE), Normalized Cross-Correlation (NCC), Structural Similarity Index Measure (SSIM), and Peak Signal-to-Noise Ratio (PSNR).

21. The apparatus of claim 16, wherein the first image and the second image are divided into grid cells, and each grid cell is associated with a feature vector.

22. The apparatus of claim 21, wherein a grid cell of the second image is dissimilar from the corresponding grid cell of the first image if a distance between a feature vector associated with the grid cell of the second image and a feature vector associated with the corresponding grid cell of the first image is above a dissimilarity threshold.

23. The apparatus of claim 22, wherein to detect if there are changes in the physical environment is based on grid cells of the second image that are dissimilar from the corresponding grid cells of the first image.

24. The apparatus of claim 22, wherein to detect if there are changes in the physical environment is based on grid cells of the second image that are dissimilar from the corresponding grid cells of the first image and have a number of neighboring grid cells dissimilar from the corresponding grid cells of the first image.

25. The apparatus of claim 16, the processing circuitry is further configured to cause the apparatus to: in response to detecting that there are changes in the physical environment, initiate a message to a user indicating that the physical environment has changed.

26. The apparatus of claim 16, wherein the apparatus is a wireless communication device.

27. The apparatus of claim 26, wherein the second image is captured by a camera of the wireless communication device.

28.-33. (canceled)
